(19) United States
(12) Patent Application Publication
(10) Pub. No.: US 2003/0172280 A1
(43) Pub. Date: Sep. 11, 2003

(54) Access control and authorization system

(76) Inventors: Edward M. Scheidt, McLean, VA (US); Ersin L. Domangue, Woodbine, MD (US)

Correspondence Address: IP STRATEGIES, P.C., Suite 500, 1730 N. LYNN STREET, ARLINGTON, VA, 22209, US

(21) Appl. No.: 10/278,765

(22) Filed: Oct. 22, 2002

Related U.S. Application Data
(63) Continuation of application No. 09/205,221, filed on Dec. 4, 1998, now Pat. No. 6,490,680.

(51) Int. Cl. H04L 9/00

(52) U.S. Cl. 713/182

(57) ABSTRACT

The invention uses symmetric key cryptography for secrecy. Role-based access controls are implemented with the use of labeled splits that are combined to generate the keys used in symmetric key cryptographic algorithms. Strong user authentication is realized with CKM technology in the form of user passwords, biometric data, and tokens, such as a supercard. Data separation, with labeling and algorithm selection, provides functionality comparable to physical separation. CKM technology lends itself to data-at-rest that may be defined as objects that exist for some time, such as computer files, databases, e-mail messages, etc. However, CKM is also suited for channel or pipeline transmitted data. CKM technology can be extended beyond applications into lower levels of a network protocol, e.g., in IEEE 802 protocols or at level 2 in the OSI model of networking. The CKM encryption protocol to establish the session key for the channel can be adapted to the parameters of the communications environment. CKM imposes a hierarchical infrastructure on an organization to securely manage splits. This infrastructure also gives CKM the ability to distribute public keys thus giving it the functionality of a Public Key Infrastructure (“PKI”). The scalability of the CKM infrastructure is better than that of other proposed PKI's which need extra bandwidth over the network to exchange certificates and public keys. In CKM, digital signatures and the Diffie-Hellman key exchange between the smart card and workstation are the principle forms of asymmetric key cryptography used.

The CKM infrastructure also gives CKM the ability to implement a key recovery method. Flexibility in algorithm management means that strong symmetric key algorithms or exportable algorithms may be used.

### FIELD OF THE INVENTION

The present invention relates in general to systems to providing security for ensuring data privacy. In particular, the present invention relates to a system for providing secure, flexible access to and authorization for a communication system for data at rest and in transit on the system.

### BACKGROUND OF THE INVENTION

As an information security too], cryptography can complement changes in information technology. The growth of information systems has been phenomenal. However, today's cryptography and its key management have reached a crossroads as it attempts to adapt to the information system changes. The predominant public key management scheme of the 80's and 90's has shortcomings that will constrain the information industry from expanding into greater information sharing applications without a shift in Public Key application. A new direction in encryption is needed if the distributive enterprise solution, with its myriad information applications, is to be made.

By combining what has been learned in the implementations of Public key management and pre-80s key management, an expanded symmetrical core key management technology emerges as the better choice for bridging to the 21' Century information applications that include data-at-rest and communications security models. Issues that confront future information protection models such as “ar, data separation or role based enforcement, system performance, and multiple enterprise authentication for the user or for those workstation can be satisfied by combining enterprise wide information distribution with information control and access control capabilities while protecting the information.

An evolution in cryptographic technology is taking place. A symmetrical key management model that is particularly well suited for role-based access control systems that look to the roles users have within an organization, and to the information access that should be afforded those roles is being bound to an authentication key management model that incorporates the mathematical models of digital signatures and signed public certificates with physics properties of identification techniques as smartcards. The resultant key management technology is the basis for Constructive Key Management”” (CKM).

In recent years, both government and industry have dramatically altered their perceptions of the development and expansion of information systems. The computer heralded the practical manr˜wWon of information As its power and flexibility increased, the communications industry expanded its services and capabilities to accommodate the automated enterprise and its users. The rapid drop in prices and the explosive development of both hardware and software compounded the computer's potential power. It is interesting to note that the first microprocessor from Intel, the 4004, was introduced in July of 1969. After a brief 25 years, we are now looking at the Pentium or even faster silicon, a leap from a 4 bit, performance capability to a 64 bit, 300-Mhz capability with a billion-dollar industry attached.

Rapid growth is also evident in the conveyance of information on the software side. The entertainment world now produces games using terms like Mutual Reality and Cyberspace. This rapid advancement of information technologies has provided a somewhat uneven growth pattern, particularly in the sociological and legal arenas. Today, even the casual user has a headlong rush of information available at a level that did not exist 10 years ago. We have moved from the radio-controller, to the micro-processor, and to today's multi-processor systems with complexities that even the most prescient PC gnus did not foresee. As we have become more familiar with the capabilities of our machinery, we have followed the most human of instincts: we attempt to share our discoveries.

The sharing of IDs has also extended to the sharing of workloads and the concept of distributive processing. The computer and communications communities responded to this demand. They have increased speed and provided connective opportunities enabling the booming of links, networks, LANs, WANs, and more and more acronyms that all mean “together.” The result today is that any computer user, with a reasonable amount of equipment, can connect with just about any information application on the Internet, The age of the Intem and “Information warfare”, is upon us. The protection of selected information and selected channels of information has become a paramount concern in defense and commerce. While this evolution has been taking place in information processing Cryptography has emerged as a premier protection technology.

Keys are an essential part of all encryption schemes. Their management can be the most critical element of any cryptography-based security. The true effectiveness of key management is the ability for keys to be maintained and distributed secretly without penalizing system performance, CQ˜t % Or User interaction. The management of the keys must be scalar, must be capable of separating information flow, must include interoperability needs, and must be capable of providing information control.

A method of distributing keys predominantly used in the 30's and 90's is Public key or asymmetrical cryptography. In this method, the conversion of information to cipher text and the conversion of basic properties of the Public key method include separate encryption and decryption keys, difficulty in deriving one key from another, secret decryption keys, and public encryption keys. The implementation of Public key information encrypting keys is the result of the mathematical combination of the encryption and decryption keys. Public key management was developed for a communications channel requirement to establish cryptographic connectivity between two points after which a symmetrical cryptogen such as DES was to be executed. Over the years. Public key implementations have demonstrated their effectiveness to authenticate between two entities. However, to take the authentication process to a _global certificate process has not been successfully done. In a May I q97 report, a group of leading cryptographers and computer scientists cautioned that “The deployment of a general key-recovery-based encryption infrastructure to mm law enforcement's stated requirements will result in substantial sacrifices in security and cost to the end user. Building a secure infrastructure of the breathtaking wale and complexity demanded by these requirements in,.r beyond the experience and current competency of the filed.” I Stated, in other words, Public key management is effective in an information model that defines point-to-point communications channels where the information encrypted does not need to be recovered,

Many of the recent implementations of Public key management have left the user with an option to create their own pair-wise connectivity within the network This action can leave an organization vulnerable, mid in some cases liable, if that user leaves without identify/mg the keys previously used for encrypted files or data, Also, to assure the integrity of the public key from misuse, a third party infrastructure scheme has surfaced, A Certificate Authority process 13 created to mathematically confirm that a public key was issued to a specific user. The exchange of Certificates with a third party can significantly impact the performance of a network. Another legal question surfaces, “Is an organization ready to give a Nerd paM control over the validation of corporate correspondence?’

The Public key process has also surfaced a negative high computation time which can impact the performance of an information application In many instances, hardware solutions have compensated for the high computational requirements. semipublic key architecture has been historically a point-to-point design, moving to a distributive network with group sharing of information can create a higher transmission costs and greater network impact. VAOe the older key management system of the 90's and 90's worked well for point-w-point communications and one-to-one Me tnmsft, they are too time consuming when a single file is placed on a Me server and decrypted by thousands of users. As the trend toward work groups and complex communications infrastructures continue, the need for more efficient information and communications key management technology becomes paramount.

Shared secret keys or symmetrical key is the earliest key management design and pre dates public key management. The earlier versions of symmetrical designs suffered what was referred to as the “n-squared’ problem in that the number of keys needed was very large as a network expanded, and these designs did not have an effective authentication capability, However, symmetrical encryption his a measurable better system processing performance than public key implementations.

A new key management and distribution design has emerged that builds on the advantages, and takes into account the disadvantages, of both public and symmetrical key management implementations. Constructive Key Management (CKM) combines an encryption process based on split key capability with access control credentials and an authentication proms based on public key and identification techniques. The binding method between the symmetrical and public key processes is itself an encryption sequence that ensures integrity to the parts of the processes. DeWs of the proem are further defined in a TECSEC document referred to as Constructive Key Management Technology.

Part of CKM is a split key symmetrical encryption technology. Split keys are key modules that when combined create the session key for the encryption/decryption process, Like all encryption key management processes, a certain portion of the process has to be pre-positioned. For4″247m, the split keys that make up the Cr(Am*itial set must be distributed before a user (or a workstation) can initiate the encryption process.

CKW11 is suited for role-based access designs ftt took to the roles users have within an organization, and to the information access that should be afforded those roles, Users' access permissions are changed as their roles—oithin an organization change—As a symmetrical design, the cryptoggraphic architecture model is closed to those users given split keys. A new user (or a workstation) would have to be given, through the process, a suite of split keys to participate in the encryption or decryption process—The CKMT'd encryption process can be Wended to data-at-rest such as files or information objects that are used in a sture-and-rorward-and-read-later architecture, and the process can be part of the key exchange and the attribute exchange process for a transmission key management architecture.

CKM integrates organizational information flow and wntfol with an enciyption key creation, dist˜ributiom combining, and authentication prucess. The desi8n can support multiple syrmnetric key cryptogens or algoriftm, and uses a data encryption process of combining split keys—These split keys are created by a “Policy Manager” for overall organizativnal distribution and iamnaged through a “Credential Manager” to the user, Other administrative features are Included in the key management process such as read and write authoriM IdenOcation fieWs, a user terminal field and an access import field for directory authentication. Additio” administrative and security features can be realized with a hardware token such as the smart card. The ititernal CKM design process can be saed and adapted to various sma card implementations. For example, a 16-k/bh memory cud may contain portions of the combiner process and the authentication process with the encryption process done at the host. Additional memory and procestor capability on die card oTrrs further on-card encryption functionality and added authenticafion capabilities such as biometrics and card integrity techniques.

When a f3le or a trwmction is encrypted under CKM'Im, a unique session key is created, used, and then discarded. The session key cannot be derived ftom the file or message header. The (ffie) headcr contains the creator's idmthy and permissions (labels) indicating the audience of the file, The labels and the algorithm form a matrix for separating access to information. The labels may be defined by the organi=tion, or defined for a workstation's authority, or may be Wected by the user. Upon rmeipt, the header is decrypted and the permission labels are coqxred to those of the recipient. If the comparison [a favorable, other splits are obtained and combined, the session key is reconstructed, and the file is decrypted. If the focus were on protecting the information communications channel a standardized split key exchange would be done to establish the channel (or tunnel) and to ensure encryption synchronization for maintaining the encrypted channel. Regardless of whether an object is encrypted or a channel is onaypted, no session or keysplit is transmitted wfth the i*nwjon.

If necessary, an organization can recover all files since it controls the total label permission set and The corresponding key splits. Thus a private “recovery” capability is inherent within the symmetrical key management proms

In addition to the variable key splits associated with the label permission process, other key splits an used in the combining process that include a random split, an organizational—

### SUMMARY OF THE INVENTION

CKM was designed to meet goals stated above. The first level of CKM meets the objectives of secrecy, i.e. data confidentiality, access control, and user authentication. As a byproduct of the design, data separation and key recovery are available. The design of CKM also gives it the functionality of a Public Key Infrastructure. Adding public key cryptography to CKM at the second level gives it the capability to meet the last three goals that are broadly termed authentication.

CKM uses symmetric key cryptography for secrecy. Role-based access controls are implemented with the use of labeled splits that are combined to generate the keys used in symmetric key cryptographic algorithms. Strong user authentication is realized with CKM technology in the form of user passwords, biometric data, and tokens, such as a supercard. Data separation, with labeling and algorithm selection, provides functionality comparable to physical separation.

CKM technology lends itself to data-at-rest that may be defined as objects that exist for some time, such as computer files, databases, e-mail messages, etc. However, CKM is also suited for channel or pipeline transmitted data. CKM technology can be extended beyond applications into lower levels of a network protocol, e.g., in IEEE 802 protocols or at level 2 in the OSI model of networking. The CKM encryption protocol to establish the session key for the channel can be adapted to the parameters of the communications environment.

CKM imposes a hierarchical infrastructure on an organization to securely manage splits. This infrastructure also gives CKM the ability to distribute public keys thus giving it the functionality of a Public Key Infrastructure (“PKI”). The scalability of the CKM infrastructure is better than that of other proposed PKI's which need extra bandwidth over the network to exchange certificates and public keys. In CKM, digital signatures and the Diffie-Hellman key exchange between the smart card and workstation are the principle forms of asymmetric key cryptography used.

The CKM infrastructure also gives CKM the ability to implement a key recovery method. Flexibility in algorithm management means that strong symmetric key algorithms or exportable algorithms may be used.

### BRIEF DESCRIPTION OF THE DRAWINGS

FIG. 1

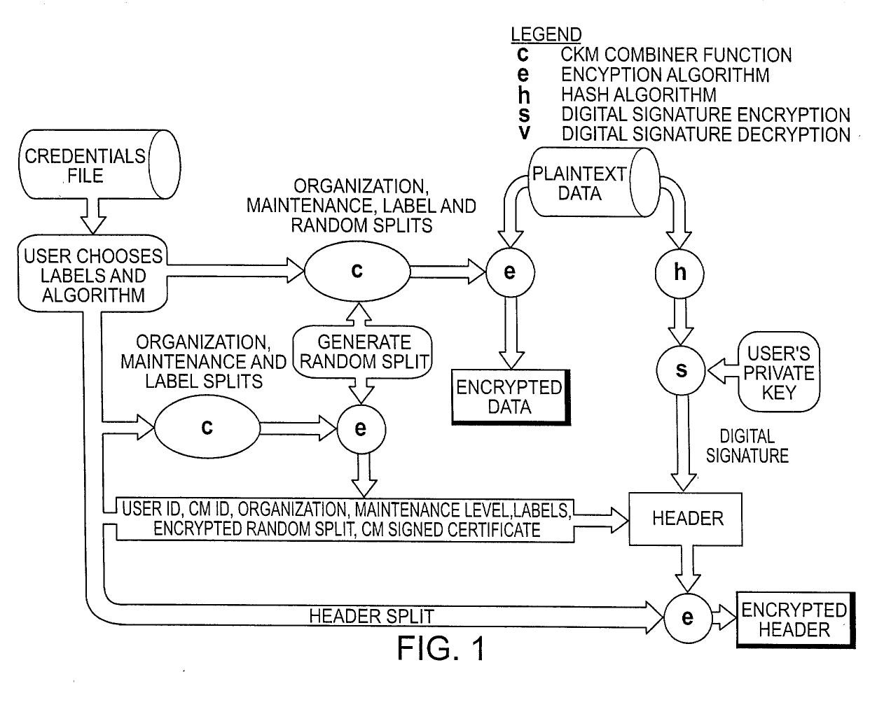

FIG. 2

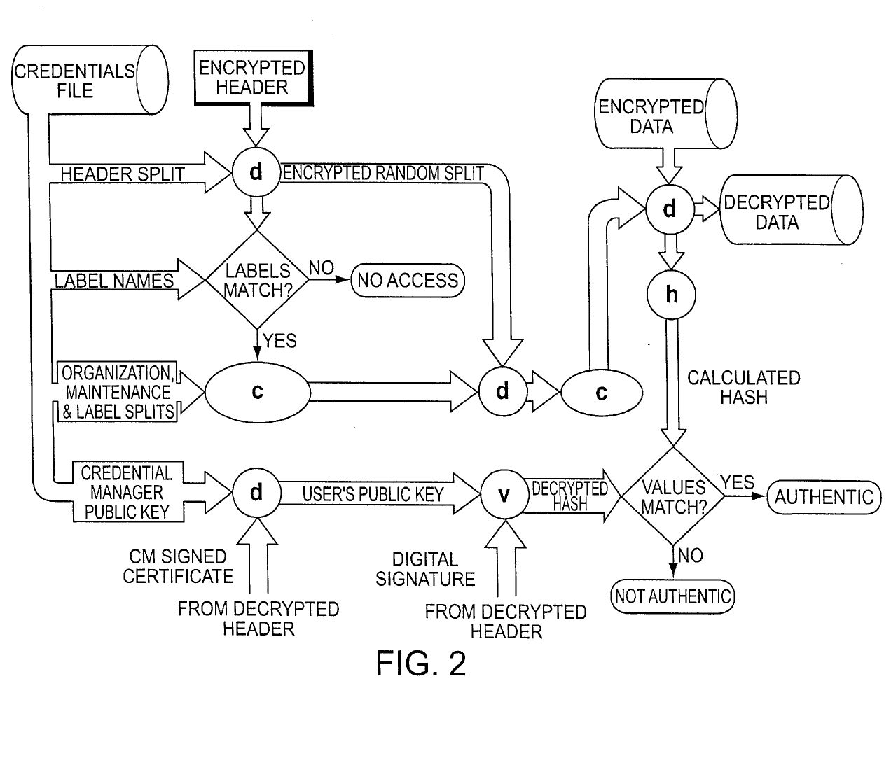

FIG. 3

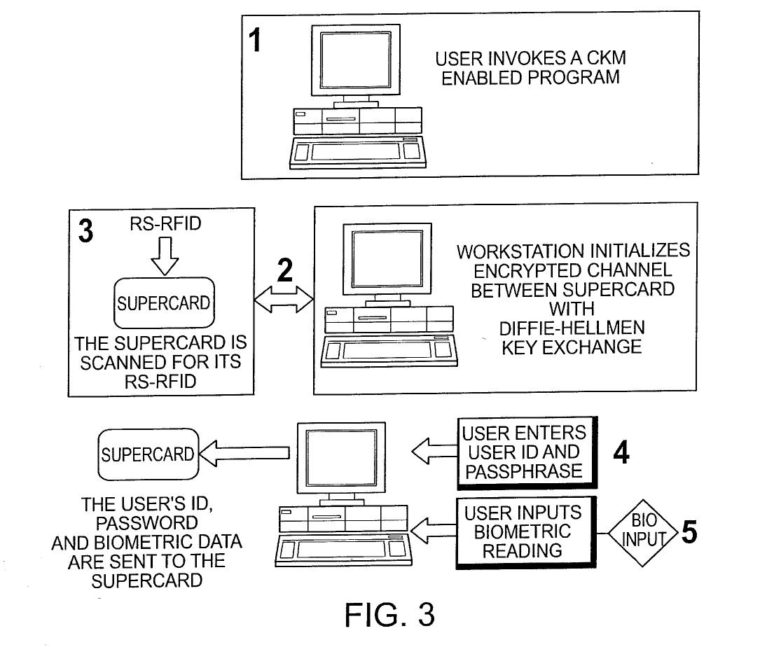

FIG. 4

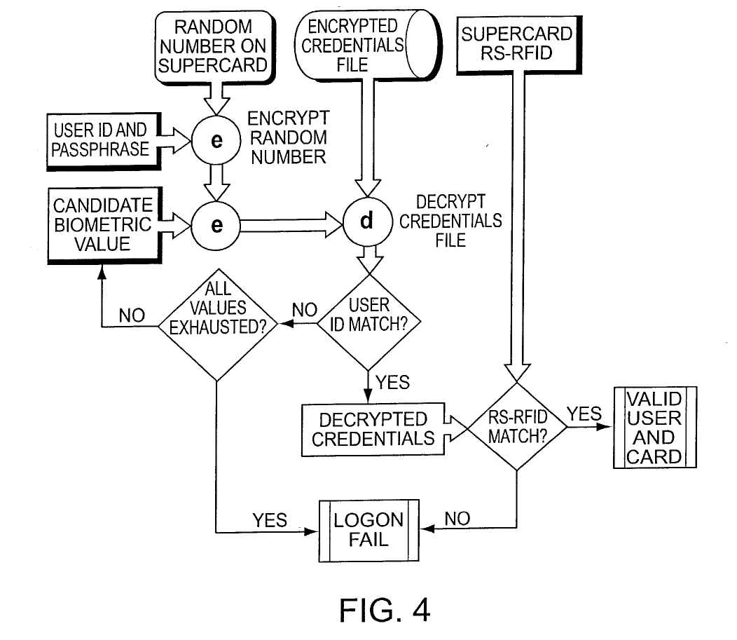

FIG. 5

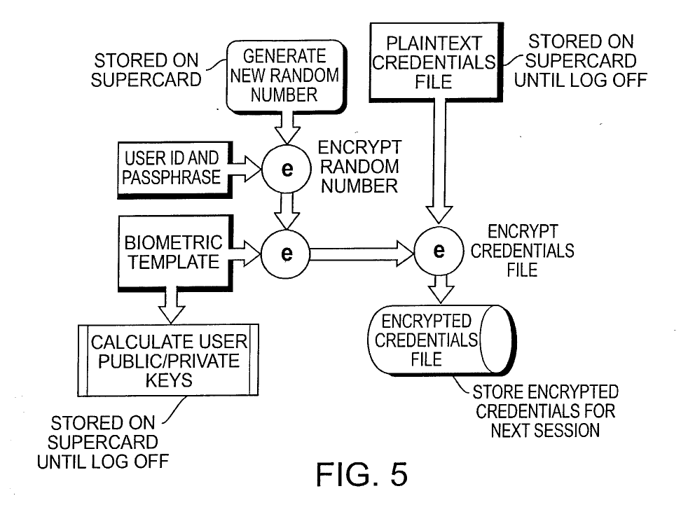

FIG. 6

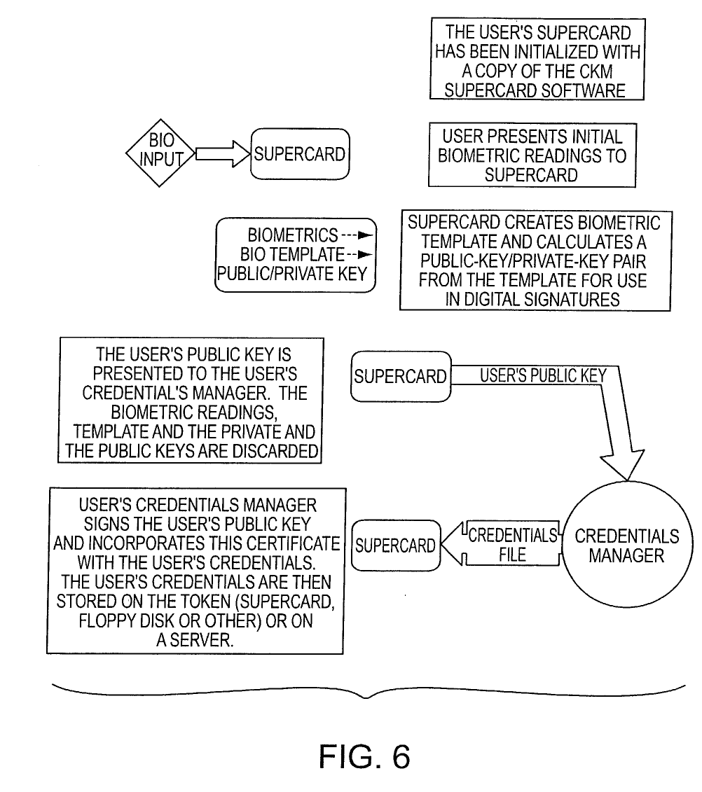

### DETAILED DESCRIPTION OF THE INVENTION

Introduction

Constructive Key Management (“CKM”) is a computer-based security technology that uses cryptography to meet its security objectives. CKM technology and enhancements are discussed which include the use of smart cards, biometrics, and digital signatures. Finally, the complete overview of the CKM process, with enhancements, is presented that illustrate the methods CKM uses to meet its security objectives.

A complete CKM technology implementation is intended to couple the strengths found in a symmetrical key management design with public key or other technology enhancements. To protect and control access to the information processing technologies planned for the future will broaden the role of key management to include data-at-rest and channeled data cryptography.

Current CKM technology meets a set of security objectives that provide the “classical” role of secrecy:

1. Data confidentiality keeps the content of information from being revealed to those who are not authorized to read it. This is realized in CKM with symmetric key cryptography using a robust key management system that provides a new and unique key for each encryption with the user “selecting” the readership for the encrypted object. An object can be a file, a message, or some other defined entity.

2. Access control restricts use of encrypted objects to those entities specifically given permission to use them. Access control in CKM is role-based; permissions are granted and revoked based on an entity's responsibility or position within an organization and not on who or what that entity is. It currently encompasses the actions of encryption and decryption but may include for example, permissions to use certain programs, certain devices, or specific hardware operating modes.

3. Entity (or user) authentication establishes the identity of a user or other entity to the system. Entity authentication becomes stronger when other enhancements, to be discussed below, are added to CKM.

Inherent in CKM are the means to meet two additional, “modern”, objectives:

4. Data separation gives the illusion that data at the same physical location, on a server or network wire for example, is physically separate. Two cryptographic means of separation are used in CKM—separation by algorithm and separation by label. More will be said about this concept below.

5. Key recovery in CKM is the ability to regenerate the keys used to encrypt objects. Within any particular CKM domain (or organization), encrypted objects are not lost with the loss of the entity that encrypted the object or the entity to which the encrypted object has been sent. But, at the same time, key recovery is an organized process requiring several deliberate events plus access to the encrypted object in order to regenerate the key and decrypt the object.

A by-product of these security objectives can be an audit of selected events. It is sometimes necessary to recreate certain actions that can tell a story about events.

Smart cards and biometrics provide greater integrity in meeting a third objective: User Authentication. A smart card can be an excellent hardware platform to adapt various levels of CKM technology. The card can be a memory only device, or it can be expanded to include processing capability. An advanced smart card shall be referred to herein as a supercard, which is an enabling technology for CKM. Along with its increased processing and memory, the supercard includes a unique radio frequency signature and random number generation capability. Adding biometrics to CKM enhances user authentication further and can provide a basis for the private key part of asymmetric key crypto systems that CKM uses for digital signatures.

A digital signature offers CKM the means to meet three additional, “conventional”, security objectives:

6. Data origin authentication (also called message authentication) corroborates the source of CKM encrypted information.

7. Data integrity is the ability to prove that a CKM encrypted object has not been altered since being encrypted and digitally signed. If digital signatures are not used, then a Message Authentication Code (MAC) or Manipulation Detection Code (MDC) with encryption can provide data integrity in CKM.

8. Non-repudiation proves that the signature on a signed object came from the signatory such that the signatory cannot deny digitally signing the object.

Overview of CKM Technology

CKM provides technology for generating and regenerating cryptographic keys and a method of managing those keys within an organization. Immediately before an object is encrypted or decrypted with CKM, a cryptographic working key is generated. It is used to initialize a cryptographic algorithm for encryption or decryption, then the working key is discarded.

The working key is built from many pieces of information. To be a participant in the system, a user must have the pieces necessary to build the key, otherwise encryption and decryption cannot take place. A central authority generates these pieces, which are called key splits in CKM; a subset of these splits are distributed to each user in the organization. The subset that each user receives is specific to that person and defines which labels that individual may use to encrypt (known as write permission in CKM) and which labels that individual may use to decrypt (known as read permission). Several user authentication techniques are further used to verify a user to the CKM system before that user is allowed access to information.

To build a key, a constant system wide-split, called the organization split and a variable system wide split, called the maintenance split are used. To this are added a random number, which is called the random split, and user selected label splits. The random split provides a unique key that is necessary for security. User selected label splits define the “readership” of the CKM encrypted object, i.e., which users will be able to decrypt the CKM encrypted object. These splits are provided to the CKM combiner process that generates data used as the working key.

CKM uses a hierarchical infrastructure to manage the distribution of information necessary for CKM enabled software to construct cryptographic keys. This infrastructure also provides a method of user certificate and public key distribution for asymmetric key cryptography so that digital signatures may be used.

The CKM Infrastructure

The core CKM design, consisting of a three-tier hierarchical system, focuses on the functions needed for encryption and decryption of objects. Another level focusing on authentication uses smart cards and optional biometrics for entity authentication and digital signatures for message authentication. A third level that adds a mix of detection techniques for internally protecting the CKM authentication and encryption processes may be added if the environment requires this protection.

At the top tier of the CKM hierarchy is a process identified as the Policy Manager. This process requires the “central authority” for the encryption domain to generate splits, which are 512 bit random numbers, to be used in key generation. Splits are labeled and are used in combination to generate cryptographic keys.

The next tier down in this hierarchy is a process identified as the Credential Manager. This process is given a subset of labels and specific algorithms from the Policy Manager. Individuals are allocated specific labels. Organizational policies and system parameters generated by the Policy Manager are added to these labels forming an individual's credentials. A user's credentials are encrypted and distributed to that user on a “token”, such as a diskette or a smart card, or installed on a server. The label allocation by the Credential Manager allows an organization to implement a “role-based” system of access to information in a logical process.

For additional ease of use, the Credentials Manager process can be further divided into a central credential database management system, a token creation/distribution process, and a password distribution process. This separation lets several people manage user credentials.

Access to a user's credentials is controlled at the bottom tier of the CKM hierarchy with a pass-phrase, initially assigned automatically by the Credential Manager. The pass-phrase is changed at the time of first use by the user and known only to the user. This provides rudimentary user authentication. Stronger authentication is provided with enhancements to CKM.

Enhancements at the user level to provide stronger user authentication include a smart card—a processor and memory packaged into a plastic card, like a credit card—that can hold key pieces of information for user authentication. A smart card can provide additional security with its tamper resistance and hardware random number generation capability.

Another authentication enhancement is the use of biometric data. Biometric data is physiological or behavioral information associated with an individual that is unique to that individual and does not change during that individual's lifetime. Furthermore, it has to be something that can be digitized and entered into a computer. Biometric data can be used in the creation of private keys for digital signatures.

For data integrity alone, a Message Authentication Code (MAC) can be used. Instead of the generated key being used to initialize symmetric key algorithms, it is used to initialize a MAC. Manipulation Detection Codes (MDCs) can be used to provide data integrity and secrecy when combined with CKM encryption.

If data origin authentication and non-repudiation are required, the CKM infrastructure is then used to provide the means to distribute public keys which give CKM the ability to use cryptographic bound digital signatures. Digital signatures provide data integrity, data origin authentication, and user non-repudiation. If a digital signature is used, MACs or MDCs are not required. Combining digital signatures with core CKM establishes the means of meeting all of the objectives stated at the beginning.

The Supercard

The supercard is a smart card with enhanced processing ability, has greater memory than current smart cards and includes tamper resistance and random number generation. The processing capability of the card may reduce CKM task processing on the workstation. In addition, local processing within the card increases the workload of an adversary who is trying to snoop the internal workings of CKM processes in order to gain information about secret keys. Larger memory within the card makes it possible to store user credential files and “private” CKM applications. This contributes to the security of the CKM system.

The communications between the supercard and the workstation is encrypted. The supercard stores a public-key/private-key pair generated internally by the card. This is done when the card is initialized with the CKM software that the supercard runs internally. This key pair is used in a Diffie-Hellman key exchange between the supercard and the workstation. This again, contributes to the security of the CKM system by not allowing an adversary to snoop passwords and keys being exchanged between the card and the workstation.

An inherently random radio frequency signature, called Resonant Signature-Radio Frequency Identification (RS-RFID), which is provided by a taggent embedded within the card, aids tamper resistance. The RS-RFID of the card is encrypted with a key based on the user's ID and password, some ephemeral information, and possibly biometric information. This encrypted value is stored in the user's credentials file. Any tampering with the card will change the RS-RFID of that card. When a damaged RS-RFID is used, the wrong radio signature is read and will not match the decrypted value in the user's credentials file. The card reader that reads the supercard contains hardware to read the RS-RFID.

Another feature of the supercard is hardware random number generation capability. As will be shown below, random numbers are needed by CKM for object encryption, as well as for other operations. In the absence of the hardware random number generation, CKM has to use a software pseudorandom number generator for the random numbers that it needs. Using a hardware source provides much better random number generation and contributes to the strength of the overall security of the CKM system.

Biometric Data

In general, biometric data as digitized from an analog biometric input device is variable to a small extent. The process of using a biometric device can be as follows: Initially, a biometric reading is taken, digitized, possibly mathematically transformed, and then stored as a template. Subsequent biometric readings are compared to this template using some tolerance value. Tolerance values are different for different types of biometric data.

If it is assumed that the template stores data of several parameters, then in matching biometric readings to the parameters the tolerance value provides a threshold for deciding if a match is successful. The continuum of values for a parameter is partitioned by the tolerance value for that parameter, into discreet quanta. When a biometric reading is taken, we can now associate the value of the quantum that the measurement falls in with the value to be used for that biometric reading. In general, however, that value may not match the quantum value stored in the template. Assuming the measurements are normally distributed and the tolerance value covers three standard deviations on either side, a correct biometric reading should fall in the same quantum as that of the template or the quantum next to it.

Therefore, an exact quantity can be generated from biometric data to be used as a constant in cryptographic processes.

It is desirable not to store a biometric reading, and this includes the template, even if it is encrypted. Using the technique above, a template value would be used but is not stored anywhere. To reconstruct the template, a biometric reading is taken, candidate values are formed, and each candidate is used as a key to decrypt some data until one of these values matches. If a match can be found, then the user has been authenticated and this matching value is the template value to be used as a constant elsewhere in the CKM process. If a match cannot be made, the user has not been authenticated, and the authentication process can be repeated or the authentication for that user fails.

Digital Signatures

Digital signatures are used in CKM to provide data origin authentication, data integrity, and non-repudiation. The infrastructure provided by CKM supports a form of a Public Key Infrastructure (PKI) that distributes signed certificates and public keys that are used in digital signature verification. In other proposed public key systems, the certificate authority takes the form of a database on a server that users query via a network. In CKM, Credential Managers play the part of a certificate authority. All information for verifying digital signatures in CKM is provided in a user's credentials and encrypted objects. Additional bandwidth from the network is therefore not required as it is in other public key infrastructures.

The certificate for a user is generated by that user's Credential Manager. Each Credentials Manager has its own public and private key. The public keys of all of the organization's Credential Managers are provided in each user's credentials. The Credential Manager encrypts a user's ID and public key combination with the Credential Manager's private key. This is the basic certificate.

A user's certificate is contained in that user's credentials so that it may be sent with CKM objects that the user has signed. The recipient of a CKM object uses the Credential Manager's public key to decrypt the sender's certificate and recovers that user's public key. The sender's public key is used to verify the digital signature on that CKM object.

In CKM, a user's biometric template forms the basis of a user's private-key. For example, in the El Gamal Signature Scheme, a public key is the combination of a prime number, p, a primitive element, α, and a value, β, computed from a private number a. This private number is usually picked at random. However, in CKM, the user's biometric template could become this private number.

To verify a digital signature, the certificate is decrypted using the corresponding Credential Manager's public key that is found in credentials. This exposes the signatory's public key which is then used to verify the digital signature.

Manipulation Detection Codes (MDCs)

If privacy and data integrity without regard to data origin authentication and non-repudiation are desired, an MDC combined with CKM encryption may be used. An MDC is basically an “unkeyed” hash function that is computed from the message. This hash is then appended to the message, and the new message is encrypted.

For verification of data integrity, a recipient decrypts the message, separates the hash from the message, computes the MDC of the recovered message, and compares this to the decrypted hash. The message is accepted as authentic if the values match.

Message Authentication Codes (MACs)

If only data integrity without regard to privacy is needed, a MAC can be used with CKM. The working key for the MAC is constructed in the same way as that for the key used for encrypting a message for privacy, viz. by using the CKM combiner process with label splits, organization split, maintenance split, and a random split.

To verify data integrity, the recipient of the MACed message uses the splits associated with the message to rebuild the key for the MAC. A new MAC is then calculated by the recipient and compared to the MAC sent with the message. If the two MACs match, the message is accepted as having been the original message and having not been tampered with.

The CKM Process with Enhancements

The following is an outline of a total CKM process used in meeting the previously-noted security objectives. In the following discussion, the “Policy Manager” refers to the person who operates the CKM Policy Manager software, and “Credential Manager” refers to a person who operates the CKM Credential Manager software.

Policy Manager

Using CKM Policy Manager software, the Policy Manager sets up the system that the organization will use. The Policy Manager:

1. Establishes a name for the organization. The Policy Manager software will generate a split. This number is associated with this name and becomes the Organization Split. In addition, system parameters are generated. This may include the modulus used for a Diffie-Hellman key exchange or other public key digital signature schemes. Additional splits—a Maintenance Split, Header Encryption Split, etc.—are generated at this time. These splits are random numbers that can be generated using hardware or through a software pseudorandom generator.

2. Creates categories for grouping labels.

3. Creates labels and groups them into categories. With each label, a random split is generated by the Policy Manager software and then associated with the label. In addition, the label is assigned a unique index number.

4. Names the cryptographic algorithms provided with the software. Associated with each name is a cryptographic algorithm along with a mode to be applied with that algorithm. This hides the actual algorithm that will be used for encryption but more importantly gives meaning to the algorithm so that it may be applied by the users in a meaningful way.

5. Decides upon policies to be applied by the organization in the use of CKM. These include things such as minimum password length, maximum credentials expiration time, where credentials are allowed to reside, logging policies, etc. It also includes selection of the digital signature algorithm to be used.

Once established, the labels, algorithms, parameters, and policies are distributed to the Credentials Managers as follows:

6. The policy Manager chooses a subset of the algorithms and labels, with possible limitations on read and write permission for each Credential manager. Then, for each Credential Manager, a distribution file is created, encrypted and sent. Passwords for decryption of these files are sent to each Credential manager over a suggested separate, secure channel.

7. The Policy manager may export a subset of labels and categories to other Policy Managers from other organizations. The policy Manager may also receive a subset of labels and categories from Policy Managers of other organizations.

8. Periodically, the Policy Manager may add labels and categories, or change policies, and then regenerate the files for each Credentials Manager and distribute them.

9. Also, periodically, the Policy manager may update the Maintenance Split. This would also require regeneration and distribution of Credential Manager files. Changing the Maintenance Split has the effect of updating all other system splits. It also effectively revokes users'permissions for users who do not receive updated credentials from their Credential Manager. This update is mathematically done such that all previously encrypted data may still be recovered.

Credentials Manager

Initialize the process:

1. The Credentials Manager will receive an encrypted file and, over a suggested separate, secure channel, the password that was used in that encryption from the Policy Manager. The Credentials Manager software will read this file, accept the password from the Credentials Manager and decrypt the information.

2. The Credentials Manager adds the users for which the Credentials Manager has responsibility, to the Credentials Manager program's database. Procedures or utilities that ease this process, such as creating a list of users from an e-mail address book, are provided in the Credentials Manager software.

3. For each user, the Credentials Manager will decide what role that user has and assign labels and algorithms to that user that are appropriate for that role. Role templates and hierarchies aid this process.

4. If a smart card is used, then for each user in the Credentials Manager database, the Credentials Manager will initialize a smart card with that user's ID. The card is then given to the user.

5. An initial biometric reading is taken to establish the biometric template, and entered onto the card. The software on the card will then generate a public/private key pair for use with a specific digital signature scheme. The private key is unavailable to the Credentials Manager.

6. For each user in the Credentials Manager database, the Credentials Manager software will accept a user's public key from that user's card. The Credentials Manager software will record this public key in the database and then create a certificate with the Credentials Manager's private key. The user should be required to be present at this step or a method should be used to assure the user's identity.

7. The user's assigned permissions to labels and algorithms, the certificate created in step 6 above, all Credential Manager's public keys, policies, and system parameters are encrypted with a system generated password. This assemblage is the user's credentials. The credentials are stored on the user's card, or in a file on another type of token, or on a server. The card and system generated first use password are given back to the user. Note that if the credentials are stored on a server, the user's credentials may be revoked at any time by erasing that user's credentials file from the server.

8. The user brings the card back to the workstation and logs in using the initial password. The CKM software will prompt the user to change the initial password and other security features. Until this password is changed the CKM software will not continue.

Utilities in the Credential Manager software facilitate ongoing maintenance, which include:

A. Issue smart cards and credentials to new users.

B. Reissue the credentials file to a user, with a new first use password, whenever those user's credentials expire. Utilities in the Credentials Manager software aid in recognizing when a user's credentials are about to expire. Not reissuing a user's credentials upon expiration will keep that user from encrypting and decrypting data. This is another means of revoking a user's credentials.

C. Reissue the credentials to all users whenever the Policy Manager adds new labels and categories or whenever the Policy Manager has updated the Maintenance Split or whenever new labels and categories from another organization are added.

Except for action A above, reissuance of credentials only requires the transfer of a first use password and new credentials file (if not stored on a server) to the users. The user does not have to be in the presence of the Credentials Manager again. Passwords can be distributed through an existing organizational administrative channel.

The access a user has to CKM encrypted objects is granted by that user's Credentials Manager. Because access is based on organization-generated labels, role-based access is possible. This simplifies the management of granting, changing, and revoking access to individuals.

CKM Session Establishment (User Logon with Authentication)

Use of the CKM system is contingent upon a successful logon and decryption of user credentials. A correct user ID, password, the correct smart card, and user biometric will successfully decrypt the credentials file thus authenticating that user to the CKM system. A wrong user ID, password, a smart card not belonging to the user, or biometric of another will not decrypt the credentials file.

At the conclusion of the initial issuance of user credentials with the smart card:

1. A random number has been generated and stored on the card. This random number serves as the swing point for the authentication process.

2. The user's credentials are stored either on a token, the user's workstation, or a server. The credentials are encrypted using a key based on a password and the user's biometric template.

The logon process is performed as follows:

1. The user runs a CKM-enabled program. The workstation has established its own public/private key pair for use with Diffie-Hellman key exchange upon installation of the CKM software.

2. A communications channel is initialized for the smart card, preferably using the ANSI X9.42 Diffie-Hellman dhMQV2 protocol. The workstation's and the card's public-keys are exchanged and ephemeral information is exchanged. A random number is generated and exchanged using the key already established, to encrypt this value. This random number then becomes the session key used to encrypt the data sent to and from the workstation and the smart card. Note that this protocol is utilized between the smart card and the workstation. A standard card reader can be used, no intelligence on the reader is needed. However, if a supercard as described above is used, the reader will need extra hardware to read the RS-RFID signature from the card. In addition, the random number will be generated on the card.

3. The program invokes a CKM session logon screen where the user presents a user ID and password. The user ID and password are sent to the card.

4. The CKM program prompts the user to present biometric data. The biometric data is read into the workstation and then sent to the card.

5. The card reader reads the supercard's RS-RFID, and sends this to the card.

6. The card uses the user ID and password to encrypt the random number stored on the card and then uses candidate biometric data to encrypt this value. This candidate value is used as a key to decrypt the user's credentials. Upon successful decryption, the user ID stored in the credentials file and the one presented by the user match.

7. The RS-RFID read from the card is compared with that encrypted in the user's credentials. If there is a match then the supercard is accepted as not having been tampered with.

Once logged on, the user will stay logged on as long as a CKM program is actively being used and while the card remains in the reader. There is an inactivity time out, set by the Credentials Manager, beyond which if the user does not actively use a CKM program, the CKM session is disabled, and the user must again present a password and possibly the biometric information and supercard (or smart card), to continue using CKM enabled software. When a user quits a CKM program, and there are no other CKM programs running at that time, the user may log off or continue to stay logged on until the time out period. Within this time out period, if another CKM-enabled program is invoked, the user does not have to log on. If, however, the time out period has lapsed, the user will have to log on yet again. During this period when no CKM-enabled program is running, and before the time out has expired, the user may run a utility program that will quickly log that user off.

The process outlined above establishes user authentication. Three elements are needed: the user's password (something known), the user's biometric data (something inherent), and the supercard or other type of token (something owned). Without a password, an adversary needs to guess or search the whole password space. A random number is used as a start for the process so that if password guessing were used the output could not so easily be detected as correct. Changing this number continually prevents an adversary from bypassing the process by watching what the result is and then “replaying” this result. Password policies, such as establishing a minimum number of characters required in a password, also help, but passwords alone are still considered weak authentication.

For “strong” authentication, biometrics and a token are also needed. Adding biometrics adds another piece of information that is needed to start a CKM session. Note that in CKM, the biometric template is not stored anywhere and so cannot be recovered without the user's biometric input. Knowledge of a user's password does not give away that user's biometric template. Conversely, knowledge of a user's biometrics does not give away that user's password. If a user's credentials are lost, candidate values taken from a biometric reading would not be able to establish the original template. However, since the template is used as the basis for a user's private key for digital signatures, the candidate values can be used to generate public keys which can be compared to the public keys stored by the user's Credentials Manager to establish once again the user's original template value.

Key pieces of information are stored on a token, such as a supercard. This token is needed to complete logon. In addition, tampering with a supercard will destroy the inherent RS-RFID signature and this would be detected. Compromise of the token does not give away either a user's password or biometrics. Loss of a token is replaceable by the user's Credentials Manager.

CKM Encryption and Decryption

Encryption of an object in CKM requires the choice of a cryptographic algorithm and a set of splits that will be used to supply data needed to construct an encryption key and will determine who will be able to decrypt the encrypted object. A feature provided is default label and algorithm selection so that the user does not always have to physically make this choice. The label and algorithms that the user has permission to use are taken from the user's credentials. Within the user's credentials file are the splits, and the labels associated with them, that the user can use to encrypt an object. The user must have write permission on those labels in order to encrypt. The user's Credentials Manager has granted those permissions when the credentials file was issued to that user. The selection of labels and algorithms and their respective permissions is how data separation is accomplished in CKM.

The labels will be grouped into categories. In general, the user encrypting an object will choose one label from each of the categories. In order for someone to be able to reconstruct the key to decrypt that object, a user will need read permission from his or her credentials file, for every one of the labels used in the encryption process of that object.

While the user is logged on, and an encrypted channel between the work station and supercard with full authentication is established, the CKM encryption process is performed as follows:

1. CKM software presents a dialog box to the user for selection of labels and algorithms.

2. The label selections are sent to the supercard.

3. The workstation applies a cryptographic hash algorithm to the object. This is sent to the supercard.

4. The supercard generates a 512 bit random number, i.e., the Random Split. New Random Splits are generated for each object encrypted. All random numbers generated are tested for randomness according to FIPS 140-1.

5. The Organization Split, Maintenance Split, the Label Splits, and the Random Split are combined in the CKM combiner process, which results in a 512 bit Working Split. This Working Split is used like a session key for encrypting one object.

6. The Organization Split, Maintenance Split, and Label Splits are combined in the CKM combiner process. This results in a 512-bit integer that is used to encrypt the Random Split that will appear in the CKM header.

7. The supercard encrypts the hash of the object with a digital signature algorithm using the user's private key. This results in a digital signature.

8. The Digital Signature, Credential Manager Signed Certificate, Label Indexes, Algorithm, encrypted Random Split, and Working Split are sent to the workstation.

9. The workstation encrypts the object using the algorithm selected with the working split as the working key.

10. The workstation forms the CKM header. The CKM header contains all of the information needed to decrypt the object and verify the digital signature except for the Label Split values and Credential Managers public keys. The data in the CKM header includes:

Organization Name

Label Indexes

Algorithm

Encrypted Random Split

User ID

User's Credential Manager ID

Object encryption date and time

The digital signature

Credential Manager Signed Certificate

Other information that may be specific to the object that was encrypted. For example, file name and attributes if the object that was encrypted was a file.

11. The CKM header is sent to the supercard where it is encrypted with the Header Split used as the key.

12. The encrypted CKM header is sent back to the workstation where it is added to the encrypted object.

The CKM decryption process is performed as follows:

1. The CKM header is sent to the supercard, where it is decrypted with the Header Split, recovering the Digital Signature and the information necessary to verify it and the Label Set Indexes that were used to encrypt the object. The Label Set Indexes and Algorithm are checked against the user's credentials and if the user has permission to decrypt the object the process continues. Otherwise a failure message is sent to the workstation.

2. The supercard uses the Label Splits and Organization Split to recover the Random Split.

3. The combiner function in the supercard is invoked with the Random Split, Label Splits, Maintenance Split, and Organization Split to reconstruct the Working Split. The Working Split and Algorithm are sent to the workstation.

4. The object is decrypted at the workstation with the algorithm and Working Split.

5. A hash of the decrypted object is calculated on the workstation and sent to the supercard.

6. The supercard looks up the Credential Manager's public key from the user's credentials and decrypts the Credential Manager Signed Certificate to recover the signatory's public key and ID.

7. The signatory's ID is compared with that from the CKM header. A non-match is a failure.

8. The signatory's public key is used to decrypt the hash value from the CKM header.

9. The hash value from step 5 above is compared to the decrypted hash value from the CKM header. If they match, then the digital signature has been verified.

Notice that the splits associated with the labels that are used as the basis for the Working Key are not in the CKM header. Only pointers to those splits are in the header; the actual split values themselves are stored in the user's credentials file, i.e., they are secret. The Random Split is in the header but is encrypted using the Label Splits to generate the key for this encryption. The inclusion of the Random Split and the process used to build the Working Key means that the Working Key is random. Since Random Splits are generated for every encryption, the Working Split is never the same even if the same labels are used. The secrecy and randomness of the Working Key and the limited amount of text encrypted with that key all contribute to the confidentiality of the object being encrypted.

The strength of the cryptographic algorithms used also adds to the confidentiality of encrypted objects. The algorithms used in CKM are commercially available cryptographic algorithms. Flexibility in choosing algorithms means that exportable algorithms may be used with CKM.

The “CKM combiner process” is a proprietary algorithm. Basically it is a non-linear function of several inputs with the output being a 512-bit value. The combiner can operate on the supercard to keep adversaries from “snooping” the process. Also as an aid to thwart adversaries, the communications channel from the card to the workstation is encrypted.

What is claimed is:

1. A method for providing data security, comprising:
CKM software presents a dialog box to the user for selection of labels and algorithms.

2. The label selections are sent to the supercard.

3. The workstation applies a cryptographic hash algorithm to the object. This is sent to the supercard.

4. The supercard generates a 512 bit random number, i.e., the Random Split. New Random Splits are generated for each object encrypted. All random numbers generated are tested for randomness according to FIPS 140-1.

5. The Organization Split, Maintenance Split, the Label Splits, and the Random Split are combined in the CKM combiner process, which results in a 512 bit Working Split. This Working Split is used like a session key for encrypting one object.

6. The Organization Split, Maintenance Split, and Label Splits are combined in the CKM combiner process. This results in a 512-bit integer that is used to encrypt the Random Split that will appear in the CKM header.

7. The supercard encrypts the hash of the object with a digital signature algorithm using the user's private key. This results in a digital signature.

8. The Digital Signature, Credential Manager Signed Certificate, Label Indexes, Algorithm, encrypted Random Split, and Working Split are sent to the workstation.

9. The workstation encrypts the object using the algorithm selected with the working split as the working key.

10. The workstation forms the CKM header. The CKM header contains all of the information needed to decrypt the object and verify the digital signature except for the Label Split values and Credential Managers public keys. The data in the CKM header includes:
Organization Name
Label Indexes
Algorithm
Encrypted Random Split
User ID
User's Credential Manager ID
Object encryption date and time
The digital signature
Credential Manager Signed Certificate
Other information that may be specific to the object that was encrypted. For example, file name and attributes if the object that was encrypted was a file.

11. The CKM header is sent to the supercard where it is encrypted with the Header Split used as the key.

12. The encrypted CKM header is sent back to the workstation where it is added to the encrypted object.
